(19) United States
(12) Patent Application Publication
(10) Pub. No.: US 2022/0395000 A1
(43) Pub. Date: Dec. 15, 2022

(54) RAMEN FOR COMPANION ANIMAL AND METHOD OF MANUFACTURING THE SAME

(71) Applicant: YOUNGINBIO CO., LTD., Gunsan-si (KR)

(72) Inventors: Injeong CHOI, Gunsan-si (KR); Haeun GO, Jinan-gun (KR)

(21) Appl. No.: 17/513,480

(22) Filed: Oct. 28, 2021

(30) Foreign Application Priority Data
Jun. 15, 2021 (KR) 10-2021-0077634
Aug. 12, 2021 (KR) 10-2021-0106933

(51) Int. Cl. A23K 40/10; A23K 40/25; A23K 50/40; A23K 10/30; A23K 10/20

(52) U.S. Cl. CPC A23K 40/10; A23K 40/25; A23K 50/40; A23K 10/30; A23K 10/20

(57) ABSTRACT

Provided is ramen for companion animals and a method of manufacturing the same, and the ramen for companion animals include noodles including a grain raw material and an additive raw material, and soup powder including a powder raw material, a pulverized raw material, and an additional raw material.

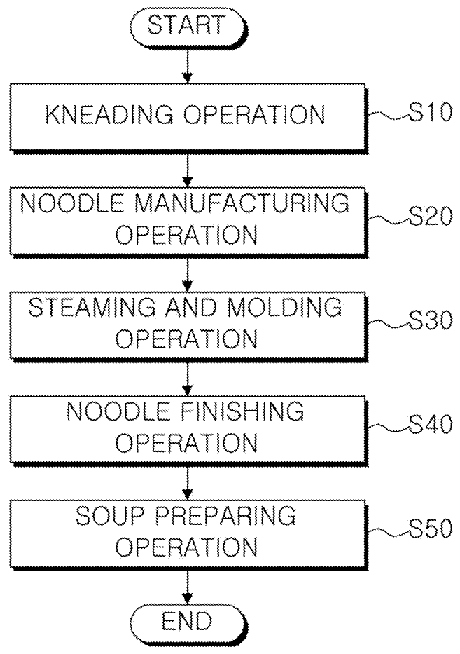

### CROSS-REFERENCE TO RELATED APPLICATION

This application claims priority to Korean Patent Application Nos. 10-2021-0077634 filed on Jun. 15, 2021, and 10-2021-0106933 filed on Aug. 12, 2021, the disclosures of which are incorporated herein by reference in their entirety.

### BACKGROUND

### 1. Field of the Invention

The present disclosure relates to ramen for companion animals and a method of manufacturing the same, and more particularly, to healthy ramen with high palatability which is ingestible by companion animals and includes various nutrients, and a method of manufacturing the same.

### 2. Discussion of Related Art

Recently, the number of households raising companion animals is increasing due to an increase in single-person households and aging of population, and thus, the marked related to companion animals is growing rapidly. Accordingly, the pet food market for companion animals is also growing rapidly, and interest in companion animal snacks manufactured with good materials for companion animals is also increasing.

However, general snacks for companion animals have types in which meat and fish preferred by companion animals are simply dried or simply processed, do not have special technical features, and are also processed and released in very general types such as treat types, dry food types, wet churro types, wet can types, and dry gum types.

In addition, since snacks for companion animals that are currently sold are manufactured of meat, when these snacks for companion animals are ingested continuously for a long period of time, bowel functions of the companion animals may be lowered to cause constipation.

Therefore, there is a need to develop a new type of snack for companion animals, which includes various nutrients required for companion animals.

### SUMMARY OF THE INVENTION

In order to solve the above problems, the present disclosure is directed to provide ramen for a companion animal, which includes various nutrients and is manufactured in the form of noodles to have high palatability.

In order to solve the above problems, ramen for a companion animal, according to an embodiment of the present disclosure includes noodles including a grain raw material and an additive raw material, and soup powder including a powder raw material, a pulverized raw material, and an additional raw material.

The grain raw material may include at least one selected from whole wheat, wheat flour, waxy barley, rice starch, and corn starch.

The grain raw material may include the whole wheat in an amount of 25 to 35 parts by weight, the wheat flour in an amount of 5 to 35 parts by weight, the waxy barley in an amount of 15 to 25 parts by weight, the rice starch in an amount of 10 to 15 parts by weight, and the corn starch in an amount of 2 to 6 parts by weight.

The additive raw material may include at least one selected from among egg yolk powder, vitamin B2, an acidity regulator, and an oligo green tea flavor liquid.

The noodles may further include a nutrient extract including at least one selected from among fennel, radish, myrrh, and radish seed.

The soup powder may include the powder raw material in an amount of 65 to 75 parts by weight, the pulverized raw material in an amount of 25 to 35 parts by weight, and the additional raw material in an amount of 0.1 to 0.5 parts by weight.

The powder raw material may include at least one selected from dried pollack, chicken, egg yolk, sweet pumpkin, banana, spinach, and broccoli in a form of dried powder.

The powder raw material may include the dried pollack in an amount of 25 to 35 parts by weight, the chicken in an amount of 8 to 12 parts by weight, the egg yolk in an amount of 15 to 25 parts by weight, the sweet pumpkin in an amount of 2 to 8 parts by weight, the banana in an amount of 2 to 6 parts by weight, the spinach in an amount of 0.3 to 0.7 parts by weight, and the broccoli in an amount of 0.3 to 0.7 parts by weight.

The pulverized raw material may include at least one selected from among of apple, carrot, and cabbage, which may be cut into a size of 0.3 cm to 0.7 cm and dried.

The pulverized raw material may further include a functional pulverized raw material, and the functional pulverized raw material may include at least one selected from among of chicon, parsnip, wax gourd, and ice plant.

The additional raw material may include at least one selected from among a bonito fragrance, coconut oil, and a lactic acid bacterium.

There may be provided a method of manufacturing ramen for a companion animal, the method including kneading a mixture including a grain raw material and an additive raw material to prepare mixture dough, extruding the mixture dough to prepare noodles, steaming the noodles using steam and then molding the steamed noodles, finishing manufacturing of the noodles by frying and then cooling the molded noodles, and mixing a powder raw material, a pulverized raw material, and an additional raw material to prepare soup powder.

### BRIEF DESCRIPTION OF THE DRAWINGS

The FIGURE is a schematic flowchart illustrating a method of manufacturing ramen for a companion animal according to an embodiment of the present disclosure.

### DETAILED DESCRIPTION OF EXEMPLARY EMBODIMENTS

Hereinafter, the description of the present disclosure with reference to the accompanying drawings is not limited to a specific embodiment thereto, and various modifications can be applied, and various embodiments can be made. Furthermore, it is to be understood that the following description covers all changes, equivalents, and alternatives falling within the scope of the spirit and technology of the present disclosure.

In the following description, the terms such as first and second are used to describe various elements, which are not limited to their own meaning, and are used only for the purpose of distinguishing one element from another element.

Like reference numerals which are used throughout the specification denote like elements.

As used herein, the singular forms “a,” “an,” and “the” include plural expressions unless the context clearly dictates otherwise. It is also to be understood that the terms “comprising,” “including,” or “having” are intended to designate the presence of features, integers, steps, operations, elements, components, or combinations thereof and should not be construed to preclude the presence or addition of one or more other features, integers, steps, operations, elements, components, or combinations thereof.

If it is not contrarily defined, all terms used herein including technological or scientific terms have the same meanings as those generally understood by a person with ordinary skill in the art. Terms defined in generally used dictionary shall be construed that they have meanings matching those in the context of a related art and shall not be construed in ideal or excessively formal meanings unless they are clearly defined in the present application.

In addition, when the present disclosure is described with the accompanying drawings, the same components will be assigned the same reference numeral regardless of the reference signs of the drawings, and the redundant description thereof will be omitted. In describing the present disclosure, a detailed description of related known functions will be omitted when it may make the essence of the present disclosure unnecessarily obscure.

Hereinafter, embodiments of the present disclosure will be described in detail with reference to the FIGURE.

The FIGURE is a schematic flowchart illustrating a method of manufacturing ramen for a companion animal according to an embodiment of the present disclosure.

Ramen for a companion animal according to an embodiment of the present disclosure is ramen ingestible by a companion animal, has high palatability, and also includes various types of nutrients, thereby being a nutritionally excellent snack. In addition, the ramen for a companion animal may include noodles and soup powder.

The noodles may refer to noodle strips of commonly known ramen and may include a grain raw material and an additive raw material.

First, the grain raw material may be a basic material for noodles and may be manufactured by kneading commonly known noodles in an elongated shape using the grain raw material.

The grain raw material may include at least one selected from whole wheat, wheat flour, waxy barley, rice starch, and corn starch.

The grain raw material may preferably include the whole wheat in an amount of 25 to 35 parts by weight, the wheat flour in an amount of 5 to 35 parts by weight, the waxy barley in an amount of 15 to 25 parts by weight, the rice starch in an amount of 10 to 15 parts by weight, and the corn starch in an amount of 2 to 6 parts by weight and may most preferably include the whole wheat in an amount of 28 to 32 parts by weight, the wheat flour in an amount of 10 to 34 parts by weight, the waxy barley in an amount of 18 to 22 parts by weight, the rice starch in an amount of 13 to 15 parts by weight, and the corn starch in an amount of 3 to 4 parts by weight, but the present disclosure is not limited thereto.

The whole wheat is prepared by removing a husk from wheat and is rich in a dietary fiber and is low in carbohydrate, and in particular, since a germ of the whole wheat is maintained, the whole wheat has an advantage of being rich in B vitamins which have an anti-aging effect. By using the whole wheat, it is possible to minimize loss of nutrients in wheat flour due to milling.

When an amount of the whole wheat is less than 25 parts by weight, an effect due to the whole wheat is insignificant, and when the amount of the whole wheat is more than 35 parts by weight, the whole wheat includes coarse fibers, and thus, viscoelasticity in noodle dough is lowered, and kneading does not perform well.

The wheat flour is used for manufacturing common noodles, and medium flour, strong flour, or a mixture thereof, which has a gluten content of 10% or more, may be used.

In the present disclosure, the wheat flour may be mixed with other materials such as the whole wheat and the waxy barley to allow kneading to be performed well. When an amount of the wheat flour is less than 5 or more than 35 parts by weight, it is not preferable because kneading may not be performed well or a texture of noodles may be degraded.

The waxy barley is barley which has been subjected to a regional adaptation test and designated as a recommended variety in 1994 after Yonezawa Mochi, that is a waxy variety, has been artificially crossed with Radiation No. 9 to cultivate waxy barley with a cross number of HB8101 in the National Honam Agricultural Experiment Station for the purpose of cultivating a variety of high-quality, premature-ripening, and disaster-resistance waxy barley having a high-yielding ability. Since such waxy barley contains a large amount of potassium to assist in maintaining blood pressure normal and also assist in maintaining alkalinity of body fluid in an optimal state. In addition, the waxy barley contains beta-glucan which is an effective material for preventing obesity by inhibiting an accumulation of fat and a butyric acid which inhibits cholesterol synthesis in a liver. In addition, since the waxy barley contains a dietary fiber in an amount that is about 10 times that in rice, it is know that the waxy barley can strengthen an intestine and can be effective for constipation.

When an amount of the waxy barley is less than 15 parts by weight, an effect due to the waxy barley is insignificant, and when the amount of the waxy barley is more than 25 parts by weight, it is not preferable because noodles are broken with snaps, and thus, noodle strips are not formed or are stiff, which lowers a texture of the noodles.

The rice starch is very small starch with a maximum diameter of 10 μm or less and has the characteristic of being non-allergenic and hypoallergenic. The rice starch may form a very fine texture in a thickening stage and thus may be used as an important material for controlling viscosity of noodle dough.

In this case, when an amount of the rice starch is less than 10 parts by weight or is more than 15 parts by weight, there is a problem in that kneading is not performed well due to viscosity of noodle dough being too low or too high.

The corn starch is just like refined starch and thus is an effective viscosity agent as compared with wheat flour. In addition, the corn starch has a high gelatinization temperature and is easily deteriorated due to a large amount of amylase content, has an excellent gel-forming ability due to viscosity higher than that of other starches, and is widely used as a general thickener and extender. Such corn starch may be used as an important material for controlling viscosity of noodle dough together with the rice starch.

In this case, when an amount of the corn starch is less than 2 parts by weight or more than 6 parts by weight, there is a problem in that kneading is not performed well due to viscosity of noodle dough being too low or too high.

Next, the additive raw material may be mixed with the grain raw material to add nutrients to noodles and also may be added such that the noodles have a good texture. The additive raw material may include at least one selected from among egg yolk powder, vitamin B2, an acidity regulator, and an oligo green tea flavor liquid.

The additive raw material is included preferably in an amount of 0.5 to 2 parts by weight and most preferably in an amount of 1 part by weight with respect to 100 parts by weight of the grain raw material.

In this case, when an amount of the additive raw material is less than 0.5 parts by weight, an effect due to the additive raw material is insignificant, and when the amount of the additive raw material is more than 2 parts by weight, it is not preferable because the additive raw material may affect health of a companion animal that ingests the ramen of the present disclosure.

The egg yolk powder is prepared by separating and pulverizing only egg yolk which is a spherical body surrounded by a yolk membrane and accounts for about 30% of an egg. Most of egg yolk proteins are lipoproteins including low density lipoprotein (LDL), livetin, phosvitin, and high density lipoprotein (HDL), as well as egg yolk riboflavin binding protein which forms a complex with riboflavin. In addition, egg yolk gelates through freezing, heating, an acid, and an alkali, and has good foamability and emulsibility, thus being used in confectionery, ice cream, mayonnaise, and the like.

This egg yolk powder not only adds a protein to noodles but also assists dough to agglomerate well.

Vitamin B2 is also called riboflavin and is used as a coenzyme in lipid metabolism with carbohydrates. In addition, it is known that vitamin B2 is not only involved in numerous oxidation-reduction reactions in our body but is also an essential component for the growth of cells of eyes, mucous membranes, skin, nails, and hair tissues.

The acidity regulator is a most widely used food additive in processed foods and is also called pH regulator. The acidity regulator adjusts acidity to restrain the propagation of microorganisms and to maintain freshness, thereby serving as a preservative for prevent food from rotting.

The oligo green tea flavor liquid is a food additive that is generally used to enhance a flavor of food in manufacturing noodles. The oligo green tea flavor liquid is a white or milky white crystal or powder, is destitute of smell, and has a unique taste, which improves an inherent taste of food and suppresses unpleasant odor and taste.

In addition, the noodles of the ramen for a companion animal according to the embodiment of the present disclosure may further include a nutrient extract.

The nutrient extract may be added to supply various nutrients to a companion animal and may be included preferably in an amount of 3 to 5 parts by weight in and most preferably in an amount of 3.5 parts by weight with respect to 100 parts by weight of the grain raw material, but the present disclosure is not limited thereto.

In this case, when an amount of the nutrient extract is less than 3 parts by weight, an effect due to the nutrient extract is insignificant, and when an amount of the nutrient extract is more than 5 parts by weight, it is not preferable because palatability may be lowered due to a unique fragrance or taste of the nutrient extract.

The nutrient extract may include at least one selected from among fennel, a radish, myrrh, and a radish seed and may include the fennel in an amount of 20 to 25 parts by weight, the radish in an amount of 15 to 20 parts by weight, the myrrh in an amount of 2 to 5 parts by weight, and the radish seed in an amount of 3 to 6 parts by weight. Most preferably, the nutrient extract may include the fennel in an amount of 23 parts by weight, the radish in an amount of 18 parts by weight, the myrrh in an amount of 4 parts by weight, and the radish seed in an amount of 5 parts by weight, but the present disclosure is not limited thereto.

The fennel is a vegetable characterized by a sweet taste and a refreshing fragrance, which assists in improving vision. Thus, in many Western countries, when vision has been weakened or inflammation has occurred, boiled water with fennel has been used as a face wash, and in Europe, the fennel has been used for urolithiasis or for detoxification. In addition, the fennel is effective in diets for preventing obesity due to excellent diuretic and weight loss effects thereof.

When an amount of the fennel is less than 20 parts by weight, an effect due to the fennel is insignificant, and when the amount of the fennel is more than 25 parts by weight, it is not preferable because the palatability of a companion animal may be lowered due to a unique fragrance of the fennel.

The radish is a vegetable which includes water in an amount of about 94%, a protein in an amount of 1.1%, fat in an amount of 0.1%, a carbohydrate in an amount of 4.2%, and a fiber in an amount of 0.7%, and thus, is low in calories but rich in water. In addition, the radish has a warm property, is sweet, is non-toxic, and has effects of assisting in digesting food, removing phlegm, softening joints, removing bad energy from five viscera, and treating symptoms such as chronic cough or coughing and hemoptysis.

When an amount of the radish is less than 15 parts by weight, an effect due to the radish is insignificant, and when the amount of the radish is more than 20 parts by weight, it is not preferable because palatability may be lowered due to a unique spicy taste of the radish.

The myrrh is prepared by coagulating a resin that is obtained by cutting a bark of commiphoramyrrha ENGL or balsamodendronehrenbergjanum BERG belonging to the Burseraceae family. The myrrh has an aromatic odor and is bitter, slightly astringent, and spicy. In addition, it is reported that the myrrh has effects such as an anti-inflammatory and analgesic effect, an anticancer effect, a lipid lowering effect, and an antimicrobial activity. The myrrh has an effect of bringing about psychological stability by enhancing a lethargic mood and alleviating an exasperated emotion.

In the present disclosure, the myrrh may be dried at room temperature, and then, a large lump thereof may be pulverized into small lumps and used.

When an amount of the myrrh is less than 2 parts by weight, a pharmacological effect due to the myrrh is insignificant, and when the amount of the myrrh is more than 5 parts by weight, it is not preferable because palatability may be lowered due to the unique aromatic odor, and the unique bitter, astringent, and spicy taste of the myrrh and a headache may be caused.

The radish seed is a ripening seed of radish (Raphanus sativus L) that is a plant belonging to the cruciferous family. A dried seed has a shape similar to an oval or round egg shape, is slightly flat, and has a length of about 3 mm and a width of 2.5 mm. A surface of the radish seed is reddish brown, several longitudinal grooves are formed at one side thereof, and there is an ovule at one end thereof. In addition, since the radish seed includes antibacterial materials, the radish seed has a distinct inhibitory action against staphylococcus and Escherichia coli and has a pharmacological effect such as an antifungal action against dermatophyte such as concentric Trichophyton. The radish seed has effects of treating a rising symptom of energy, calming breathing, assisting in digestion, and removing phlegm and is prescribed to treat bronchial asthma due to cough, dyspepsia gas, chest tightness and bloating symptoms, and tenesmus due to dysentery. Recently, it has been reported that a radish seed extract or some components exhibit strong antimutagenic activity, antibacterial, antihypertensive, and anti-inflammatory actions.

In the present disclosure, the radish seed may be dried and used.

When an amount of the radish seed is less than 3 parts by weight, a pharmacological effect due to the radish seed is insignificant, and when the amount of the radish seed is more than 6 parts by weight, it is not preferable because palatability may be lowered due to a unique spicy taste of the radish seed.

Such a nutrient extract may be used in the form of an extract extracted in boiling water for a long time.

More specifically, after a nutrient extract material is added in an amount of 30 to 40 parts by weight with respect to 100 parts by weight of water and extracted at a temperature of 85° C. to 95° C. for 4 hours to 6 hours, the material is taken out and used as the nutrient extract. Most preferably, after a nutrient extract material is added in an amount of 35 parts by weight with respect to 100 parts by weight of water and extracted at a temperature of 90° C. for 5 hours, the material may be used as the nutrient extract.

In this case, when the nutrient extract is extracted and used under conditions below such a lower limit, an effect due to the nutrient extract is insignificant, and when the conditions exceed the lower limit, due to a strong unique flavor or taste of a material of the nutrient extract, palatability may be lowered.

As described above, the ramen for a companion animal according to the embodiment of the present disclosure further includes the nutrient extract, nutrients can be supplied to a companion animal ingesting the ramen to maintain companion animal's health.

The soup powder of the ramen for a companion animal according to the embodiment of the present disclosure is edible by a companion animal by removing salt from the soup powder that is the most problematic of an existing ramen, and the soup powder is added and mixed to cooked noodles to allow the companion animal to eat the ramen.

Such soup powder may include a powder raw material, a pulverized raw material, and an additional raw material, which are harmless to a companion animal and provide various nutrients as well as enhance palatability.

In this case, the soup powder may include the powder raw material in an amount of 65 to 75 parts by weight, the pulverized raw material in an amount of 25 to 35 parts by weight, and the additional raw material in an amount of 0.1 to 0.5 parts by weight and may most preferably include the powder raw material in an amount of 71 parts by weight, the pulverized raw material in an amount of 30 parts by weight, and the additional raw material in an amount of 0.2 parts by weight, but the present disclosure is not limited thereto. Accordingly, since the soup powder includes a mixture having such a proportion, the soup powder may be prepared to be highly palatable and rich in nutrients so that a companion animal can eat deliciously to maintain health thereof.

First, the powder raw material may include at least one selected from dried pollack, chicken, egg yolk, sweet pumpkin, banana, spinach, and broccoli in the form of dried powder.

In this case, the powder raw material may include the dried pollack in an amount of 25 to 35 parts by weight, the chicken in an amount of 8 to 12 parts by weight, the egg yolk in an amount of 15 to 25 parts by weight, the sweet pumpkin in an amount of 2 to 8 parts by weight, the banana in an amount of 2 to 6 parts by weight, the spinach in an amount of 0.3 to 0.7 parts by weight, and the broccoli in an amount of 0.3 to 0.7 parts by weight.

Most preferably, the powder raw material may include the dried pollack in an amount of 30 parts by weight, the chicken in an amount of 10 parts by weight, the egg yolk in an amount of 20 parts by weight, the sweet pumpkin in an amount of 5 parts by weight, the banana in an amount of 4 parts by weight, the spinach in an amount of 0.5 parts by weight, and the broccoli in an amount of 0.5 parts by weight, but the present disclosure is not limited thereto.

The dried pollack is fish that has an ordinary property and a sweet and plain taste. The dried pollack has various names such as pollack, frozen pollack, kodari, young walleye pollack, hwangtae, and the like and has various effects such as eye fatigue recovery, diuretic action, and hangover relief.

Since such dried pollack has a fragrance or taste liked by a companion animal, the dried pollack can not only supplement nutrients but also increase palatability. In this case, when an amount of the dried pollack is less than 25 parts by weight, an effect due to the dried pollack is insignificant, and when an amount of the dried pollack is more than 35 parts by weight, it is not preferable because a fishy smell of the dried pollack is strong.

The chicken is the most representative low-fat and high-protein food and contains all essential amino acids necessary for animals, and in particular, chicken breast has the least fat content and the most protein content among chicken parts and includes more essential amino acids including methionine than beef. Thus, the chicken breast has an effect of preventing animals from contracting a disease easily.

Such chicken is the most important material for providing a protein to a companion animal. When an amount of the chicken is less than 8 parts by weight, a sufficient protein may not be provided to the companion animal. When the amount of the chicken is more than 12 parts by weight, it is not a preferable that, since a ratio of the chicken is increased as compared with other vegetables and fruits, a nutrient imbalance may be caused.

Egg yolk is prepared by separating only egg yolk which is a spherical body surrounded by a yolk membrane and accounts for about 30% of an egg. Most of egg yolk proteins are lipoproteins, including LDL, livetin, phosvitin, and HDL as well as an egg yolk riboflavin binding protein which forms a complex with riboflavin.

In addition, since the egg yolk contains a large amount of lecithin, the egg yolk is known to be effective in preventing a heart disease by discharging waste matter.

When an amount of the egg yolk is less than 15 parts by weight, nutrients ingested due to the egg yolk are insignificant, and when the amount of the egg yolk is more than 25 parts by weight, it is not preferable because a cholesterol ratio is increased.

Sweet pumpkin is a vegetable that is rich in carbohydrates and nutrients but is low in calories and is also rich in dietary fiber, thereby assisting in digestion. In addition, the sweet pumpkin is high in starch, minerals, and vitamins, and large amounts of vitamin A and beta-carotene included therein suppress aging and prevent adult diseases.

Such sweet pumpkin can not only impart a sweet taste to the soup powder but also provide various nutrients. When an amount of the sweet pumpkin is less than 2 parts by weight, an effect due to the sweet pumpkin is insignificant, and when the amount of the sweet pumpkin is more than 8 parts by weight, it is not preferable because, since a carbohydrate is increased due to an increase in ratio of the sweet pumpkin, a nutrient imbalance may be caused.

Since banana is rich in potassium and dietary fiber, the banana is known as a healthy fruit. The banana is a low-calorie food with almost no fat and very little sodium. The banana is rich in sweet taste and thus is effective in increasing palatability of the ramen for a companion animal.

In this case, when an amount of the banana is less than 2 parts by weight, an effect due to the banana is insignificant, and when the amount of the banana is more than 6 parts by weight, it is not preferable because a cellotonin component of the banana, which increases blood pressure, may affect a companion animal.

The spinach is a completely nutritious vegetable that contains not only three major nutrients but also large amounts of moisture, vitamins, and minerals. In particular, a folic acid of the spinach is known to improve a brain function and reduce a dementia risk. In addition, since a red root of the spinach contains a large amount of copper and manganese that decompose and discharge a uric acid, which is harmful to the human body, it is better to ingest the red root of the spinach together with a leaf thereof.

When an amount of the spinach is less than 0.3 parts by weight, a nutrient intake effect provided by the spinach is insignificant, and when the amount of the spinach is more than 0.7 parts by weight, it is not preferable because palatability may be lowered due to the spinach.

The broccoli is rich in antioxidants such as vitamin C and beta-carotene. Beta-carotene is a precursor of vitamin A and is a micronutrient with an antioxidant action. Antioxidants remove harmful free radicals from our body and prevent aging, cancer, and adult diseases such as heart disease.

Large amounts of calcium and vitamin C contained in the broccoli assist in preventing osteoporosis. With respect to 100 g of the broccoli, vitamin C is contained in an amount of 98 mg which is twice that in a lemon and seven times that in a potato. Therefore, two or three broccoli can provide an amount of vitamin C recommended for a day.

When an amount of the broccoli is less than 0.3 parts by weight, a nutrient intake effect provided by the spinach is insignificant, and when the amount of the broccoli is more than 0.7 parts by weight, it is not preferable because palatability may be lowered due to the broccoli.

Next, the pulverized raw material may include at least one selected from among of an apple, a carrot, and a cabbage in a form that is dried by being cut into a size of 0.3 cm to 0.7 cm.

The pulverized raw material is formed to have a certain size such that a companion animal which ingests the ramen for a companion animal appropriately performs sufficient mastication movement. The pulverized raw material is most preferably formed to have a size of 0.6 cm.

In this case, when the pulverized raw material is formed to have a size that is less than 0.3 cm, it is difficult to provide mastication movement to a companion animal, and when the pulverized raw material is formed to have a size that is more than 0.7 cm, it is not preferable because palatability of the companion animal may be lowered due to repeated mastication movement.

In addition, when the pulverized raw material is included in an amount that is less than 25 parts by weight in the soup powder, it is difficult to provide sufficient mastication movement to the companion animal, and also it is difficult to ingest nutrients of a material included in the pulverized raw material. On the other hand, when the pulverized raw material is included in an amount that is more than 35 parts by weight in the soup powder, since the pulverized raw material accounts for a larger proportion than the powder raw material, palatability of the soup powder may be lowered.

In addition, the pulverized raw material may include the apple in an amount of 20 to 40 parts by weight, the carrot in an amount of 10 to 15 parts by weight, and the cabbage in an amount of 5 to 9 parts by weight and may most preferably include the apple in an amount of 30 parts by weight, the carrot in an amount of 12 parts by weight, and the cabbage in an amount of 8 parts by weight.

The apple is a fruit that is rich in flavor component and juice and thus is widely used. As the apple ripens, since a significant amount of starch is decomposed into sugars, ripe apples have a high sugar content.

An apple fruit contains vitamins and organic acids, and a representative organic acid is a malic acid. It has been reported in academia that a triterpenoid and polyphenol, which are components contained in an apple peel, prevent cancer cell growth and kill cancer cells.

In particular, polyphenols have an antioxidant function to serve as an antioxidant in a living body, thereby contributing to health maintenance and disease prevention. In addition, the polyphenols prevent cholesterol from being absorbed into a digestive tract and thus also serve to lower a blood cholesterol level.

Such an apple is added to increase palatability through a sweet taste and provide the above-described effects. When an amount of the apple is less than 20 parts by weight, an effect due to the apple is insignificant, and when the amount of the apple is more than 40 parts by weight, it is not preferable because, since a sweet taste of the apple is too strong, palatability of the ramen for a companion animal may be lowered.

The carrot is a carbohydrate mainly having a water content of 86% to 95% and including an edible portion of about 10%. A carrot having a medium size (of about 61 g) contains 25 calories and 4 g of a digestible carbohydrate. The carrot is a complete diet health food with extremely low protein and fat. In particular, the carrot is an antioxidant food that is rich in beta-carotene, fiber, vitamin K (involved in blood clotting), potassium (K), and the like and assists in weight loss, lowers blood cholesterol level, and promotes eye health.

When an amount of the carrot is less than 10 parts by weight, the above-described effects due to the carrot is insignificant, and when the amount of the carrot is more than 15 parts by weight, it is not preferable because palatability of the ramen for a companion animal may be lowered due to an increase in amount of the carrot.

The cabbage is particularly effective in assisting in stomach health and has effects such as cancer prevention, blood circulation, detoxification, and constipation improvement. In addition, the cabbage is a low-calorie and low-fat food and is high in dietary fiber and thus gives satiety, assists in reducing an amount of food, and activates bowel movement to prevent constipation.

When an amount of the cabbage is less than 5 parts by weight, the above-described effects due to the cabbage are insignificant, and when the amount of the cabbage is more than 9 parts by weight, it is not preferable because palatability of the ramen for a companion animal may be lowered due to an increase in amount of the cabbage.

The pulverized raw material including the above-described materials may further include a functional pulverized raw material.

The functional pulverized raw material may be added to nutritionally supplement the existing pulverized raw material and may further include at least one selected from among of a chicon, a parsnip, a wax gourd, and an ice plant.

In addition, the functional pulverized raw material may be included in an amount of 10 to 15 parts by weight and most preferably in an amount of 13 parts by weight with respect to 100 parts by weight of the existing pulverized raw material.

When an amount of the functional pulverized raw material is less than 10 parts by weight, an effect due to the carrot is insignificant, and when the amount of the functional pulverized raw material is more than 15 parts by weight, it is not preferable because palatability may be lowered due to a unique flavor and taste of the material constituting the functional pulverized raw material.

In addition, the functional pulverized raw material may include the chicon in an amount of 0.2 to 0.5 parts by weight, the parsnip in an amount of 0.5 to 0.8 parts by weight, the wax gourd in an amount of 0.6 to 0.8 parts by weight, and the ice plane in an amount of 0.3 to 0.6 parts by weight and may most preferably include the chicon in an amount of 0.3 parts by weight, the parsnip in an amount of 0.6 parts by weight, the wax gourd in an amount of 0.7 parts by weight, and the ice plant in an amount of 0.5 parts by weight, but the present disclosure is not limited thereto.

The chicon is a type of endive and is rich in vitamin A. The chicon contains a large amount of carotene iron, in particular, inulin that is natural insulin. Such a chicon contains digestive and diuretic components and is effective in preventing rheumatism, arthritis, gout, and the like.

When an amount of the chicon is less than 0.2 parts by weight, an effect due to the chicon is insignificant, and when the amount of the chicon is more than 0.5 parts by weight, it is not preferable because palatability of the ramen for a companion animal may be lowered due to a unique bitter taste of the chicon.

The parsnip tastes similar to a carrot but is sweeter than the carrot, has a root taste similar to that of a turnip, and is also called a sugar carrot. In addition, the parsnip is richer in minerals and vitamins than a carrot and particularly contains a large amount of potassium, which assists in discharging sodium. In addition, the parsnip is rich in fiber, which facilitates digestion and bowel movements. In addition, the parsnip is rich in vitamin C, contains sucrose, and is high in potassium. Thus, the parsnip performs a diuretic action, reduces a risk of developing diabetes, and assists in preventing ovarian cancer.

When an amount of the parsnip is less than 0.5 parts by weight, an effect due to the parsnip is insignificant, and when the amount of the parsnip is more than 0.8 parts by weight, it is not preferable because a strong sweet taste of the parsnip may affect a vegetable extract.

The wax gourd is an annual plant belonging to the gourd family and is rich in calcium, potassium, phosphorus, and vitamin C. It is recorded in Donguibogam that the wax gourd treats diabetes, is beneficial to large and small intestines, and is good for alleviation of fever, edema, and diuretic action. In addition, the wax gourd has medicinal properties in a stem, a leaf, a fruit, a peel, and a seed thereof. Recently, the wax gourd has been popular as a diet food due to being effective in obesity and constipation.

When an amount of the wax gourd is less than 0.6 parts by weight, an effect due to the wax gourd is insignificant, and when the amount of the wax gourd is more than 0.8 parts by weight, it is not preferable because the wax gourd may cause abdominal pain.

The ice plant is a succulent plant with a low germination rate and a slow growth rate, and transparent crystals (blood cells) on a surface thereof contain various minerals and useful components for the human body, such as inositol and beta-carotene.

In addition, since the ice plant contains a large amount of pinitol which lowers a blood sugar level and a large amount of myoinositol which suppresses a triglyceride, the ice plant is a vegetable suitable for diabetic patients when leaves and stems thereof are eaten raw or used as a juice.

When an amount of the ice plant is less than 0.3 parts by weight, an effect due to the ice plant is insignificant, and when the amount of the ice plant is more than 0.6 parts by weight, it is not preferable because a salty taste of the ice plant may affect a vegetable extract.

Finally, the additional raw material of the ramen for a companion animal according to the embodiment of the present disclosure may be added to improve palatability of the ramen for a companion animal and to improve an intestinal environment of a companion animal and may include at least one selected from among a bonito fragrance, coconut oil, and a lactic acid bacterium.

In this case, when an amount of the additional raw material is less than 0.1 parts by weight, an effect due to the additional raw material is insignificant, and when the amount of the additional raw material is more than 0.5 parts by weight, it is not preferable because palatability may be lowered and stomach pain may be caused.

The bonito fragrance is added to enhance palatability through a unique fragrance of the bonito fragrant and is an additive that refers to a bonito fragrance made by maturing and smoking a bonito.

The coconut oil is vegetable oil extracted by drying and pressing flesh of a coconut fruit and is extracted by pressing a fresh coconut at a low temperature without adding chemicals, wherein nutrient destruction is low, a unique nutty fragrance and taste of the coconut are maintained, and a color of the coconut oil is pale yellow. A lauric acid, which is a saturated fatty acid of the coconut oil, is a medium chain fatty acid and is burned immediately when entering a body to produce energy and assist in preventing heart disease without negatively affecting cholesterol.

The lactic acid bacterium refers to a bacterium that produces a lactic acid as a main product as a result of fermentation among bacteria that grow through fermentation. The lactic acid bacterium may be added to improve an intestinal environment of a companion animal.

The lactic acid bacterium may include a lactic acid bacterium or Bifidobacterium including at least one selected from among Bacillus subtilis, Saccharomyces cerevisiae, Lactobacillus acidophilus, Lactobacillus brevis, and Lactobacillus plantarum. It is most preferable to use Lactobacillus plantarum alone, but the present disclosure is not limited thereto.

As described above, by mixing the respective materials in an optimal amount, it is possible to manufacture the ramen for a companion animal, which is highly palatable and is rich in nutrients. When the above range is exceeded, the taste and texture of the ramen for a companion animal may not be properly revived, or a strength of the noodles may not be adequate and thus be easily broken or tough. Therefore, it may be preferable to keep the above ratio in order to satisfy a taste of the majority.

In the method of manufacturing ramen for a companion animal according to one embodiment of the present disclosure, through kneading operation S10, noodle manufacturing operation S20, steaming and molding operation S30, noodle finishing operation S40, and soup powder preparing operation S50, ramen for a companion animal may be manufactured.

In this case, the remaining operations except for soup powder preparing operation S50 may be operations of manufacturing noodles. According to the situation, soup powder manufacturing operation S50 may be performed first, but the present disclosure is not limited thereto.

Kneading operation S10 is an operation of kneading a mixture including a grain raw material and an additive raw material to prepare mixture dough. Here, a weight ratio of each of the grain raw material and the additive raw material is the same as that described in the ramen for a companion animal, and thus, descriptions thereof will be omitted.

First, in preparing the mixture dough, 300 ml to 400 ml of purified water at room temperature per 1 kg of the mixture may be introduced into a kneader to perform kneading for 0.5 hours to 1 hour and complete the mixture dough. It is most preferable that 360 ml to 380 ml of purified water at room temperature per 1 kg of the mixture is introduced into the kneader to then perform kneading for 0.8 hours with a power of 2 to 4 horsepower, but the present disclosure is not limited thereto.

In this case, when the mixture is kneaded below a lower limit, kneading may not be performed well, and when the mixture is kneaded beyond the lower limit, productivity may be decreased as well as dough having a tough texture may be prepared, which may lower palatability.

After that, when the mixture dough is completed, maturing is performed for 12 hours to 24 hours by maintaining a temperature of 5° C. to 30° C.

It is most preferable that, after the mixture dough completed through primary kneading is primarily matured at a low temperature of 5° C. to 10° C. for 1 hour to 2 hours, the mixture dough is secondarily kneaded for 10 minutes to 15 minutes and then is secondarily matured at a temperature of 25° C. to 30° C. for 10 hours to 15 hours, thereby completing the mixture dough, but the present disclosure is not limited thereto.

Meanwhile, during maturing of dough, when the maturing is performed at a temperature less than 5° C., the maturing is not properly performed, and when the maturing is performed at a temperature exceeding 30° C., the maturing proceeds rapidly. Thus, there are problems in that a degree of maturing is difficult to adjust and the dough is also discolored. Therefore, it is preferable that the maturing is performed at a constant temperature.

Noodle manufacturing step S20 is an operation of extruding the mixture dough to manufacture noodles and is an operation of introducing the matured mixture dough into a noodle extruder to prepare the noodles. It is most preferable that extrusion molding is performed by applying heat at a temperature of 60° C. to 75° C., but the present disclosure is not limited thereto. In this case, when heat is applied at a temperature less than 60° C., the mixture dough may not pass well through the noodle extruder, and when heat is applied at a temperature exceeding 75° C., it is not preferable because the mixture dough may be boiled and hardened.

Here, it is preferable that the ramen for a companion animal of the present disclosure is manufactured such that a noodle strip manufactured through an extruder has a thickness of 1.3 mm to 1.5 mm.

In this case, when a thickness of the noodles is less than 1.3 mm, a companion animal may not easily chew the noodles, resulting in a decrease in preference for the ramen. On the other hand, when the thickness of the noodles is greater than 1.5 mm, a companion should cut the noodles to a certain size when feeding the companion animal.

Steaming and molding operation S30 is an operation of steaming the noodles using steam and then molding the noodles. Steam at a temperature of 130° C. to 220° C. may be supplied onto surfaces of the prepared noodles and supplied for 5 minutes to 9 minutes to steam the noodles with the steam.

It is most preferable that the noodles are supplied to steam at a temperature of 150° C. for 8 minutes and steamed, but the present disclosure is not limited thereto.

In this case, when the noodles are steamed below a lower limit, the noodles may not be entirely steamed, and when the noodles are steamed beyond the upper limit, it is not preferable because a shape of the noodles may be deformed.

Thereafter, it is preferable that the steamed noodles are cut to a certain length using a cutter before molding, but the present disclosure is not limited thereto.

In this case, the noodles may be cut to a length of 10 cm to 20 cm. Most preferably, the noodles may be cut to a length of 15 cm to allow the companion animal to rapidly ingest the noodles.

The noodles cut as described above may be introduced into a certain lead mold and molded into a certain shape. In this case, the lead mold may include all molds generally used for molding ramen, but the present disclosure is not limited thereto.

Noodle finishing operation S40, which is a final operation among noodle manufacturing operations, is an operation of finishing the manufacturing of the noodles by frying and then cooling the molded noodles.

In this case, various types of fats and fat oils may be used for frying the noodles, but in general, it is most preferable to use refined palm oil used when ramen noodles are fried, but the present is not limited thereto.

More specifically, noodle finishing operation S40 is preferably performed for 90 seconds to 120 seconds at a frying temperature of 160° C. to 168° C. when the noodles are fried, but the present disclosure is not limited thereto.

In this case, when a frying condition is less than a lower limit, the noodles may not be properly fried and may absorb oil to become wet, and when the frying condition exceeds an upper limit, the noodles may burn, which is not preferable.

Thereafter, in noodle finishing operation S40, after the frying, the noodles may be dried at a room temperature to set a ratio of water contained in the noodles within 1% so that the noodles may be packed as a dried product and sold.

Soup powder preparing operation S50 is an operation of preparing soup powder. The soup powder may be prepared by mixing a powder raw material, a pulverized raw material, and an additional raw material.

Here, a weight ratio, a size, and the like of each of the powder raw material, the pulverized raw material, and the additional raw material are the same as those described in the ramen for a companion animal, and thus, descriptions thereof will be omitted.

In soup powder preparing operation S50, the powder raw material may be first mixed, and then the pulverized raw material may be added and mixed to prepare a first mixture.

In addition, a bonito fragrance may be added and mixed to coconut oil to prepare a second mixture, the second mixture may be added and mixed to the first mixture, and then, a lactic acid bacterium may be added to end soup powder preparing operation S50.

Thereafter, the method of manufacturing ramen for a companion animal according to one embodiment of the present disclosure may further include a packaging operation.

The packaging operation is an operation of packaging the manufactured noodles and the prepared soup powder. The noodles and the soup powder may be packaged through an automatic packaging machine. In this case, it is preferable that the soup powder is packaged separately from the noodles and then introduced into the automatic packaging machine and packaged together with the noodles.

In addition, in packed ramen, ramen, which does not meet a weight criterion, may be sorted through a weight sorter, and ramen containing foreign substances may be automatically sorted through an X-ray detector.

Accordingly, in the ramen for a companion animal according to the embodiment of the present disclosure, ramen for a companion animal, which does not meet a weight criterion and containing foreign substances in a packaged state, may be sorted, and thus, good quality ramen for a companion animal may be provided to consumers.

Hereinafter, ramen for a companion animal and a method of manufacturing the same of the present disclosure will be described in detail through Examples, Comparative Examples, and Experimental Examples.

The following Experimental Examples are provided to help understanding and are only illustrative of the present disclosure, and the scope of the present disclosure is not limited to the following Experimental Examples.

### Example 1

Ramen for a companion animal, which includes noodles and soup powder, was manufactured.

The noodles included a grain raw material in an amount of 100 parts by weight and an additive raw material in an amount of 1 part by weight (egg yolk powder, vitamin B2, acidity regulator, and oligo green tea flavor liquid). The soup powder included a powder raw material in an amount of 71 parts by weight (dried pollack in an amount of 30 parts by weight, chicken in an amount of 10 parts by weight, egg yolk in an amount of 20 parts by weight, sweet pumpkin in an amount of 5 parts by weight, banana in an amount of 4 parts by weight, spinach in an amount of 0.5 parts by weight, and broccoli in an amount of 0.5 parts by weight), a pulverized raw material in an amount of 30 parts by weight (apple in an amount of 30 parts by weight, carrot in an amount of 12 parts by weight, and cabbage in an amount of 8 parts by weight), and an additional raw material in an amount of 0.2 parts by weight (bonito fragrance, coconut oil, and lactic acid bacterium (Lactobacillus plantarum)).

In this case, the pulverized raw material was formed to have a size of 0.6 cm.

### Example 2

Ramen for a companion animal was manufactured in the same manner as in Example 1 except that the noodles further included a nutrient extract in an amount of 3.5 parts by weight (fennel in an amount of 23 parts by weight, radish in an amount of 18 parts by weight, a myrrh in an amount of 4 parts by weight, and radish seed in an amount of 5 parts by weight).

### Example 3

Ramen for a companion animal was manufactured in the same manner as in Example 1 except that the ramen for a companion animal further included a functional pulverized raw material in an amount of 13 parts by weight (chicon in an amount of 0.3 parts by weight, parsnip in an amount of 0.6 parts by weight, wax gourd in an amount of 0.7 parts by weight, and ice plant in an amount of 0.5 parts by weight) with respect to 100 parts by weight of a pulverized raw material.

### Comparative Example 1

Ramen for a companion animal was manufactured in the same manner as in Example 1 except for a powder raw material (dried pollack in an amount of 50 parts by weight, chicken in an amount of 10 parts by weight, egg yolk in an amount of 20 parts by weight, sweet pumpkin in an amount of 5 parts by weight, banana in an amount of 4 parts by weight, spinach in an amount of 0.5 parts by weight, and broccoli in an amount of 0.5 parts by weight).

### Comparative Example 2

Ramen for a companion animal was manufactured in the same manner as in Example 1 except that a pulverized raw material was formed to have a size of 1 cm.

### [Experimental Example 1] Sensory Evaluation 1

Sensory evaluation was performed on Examples 1 to 3 and Comparative Examples 1 and 2.

Palatability evaluation of one serving of the ramen for a companion animal of Examples 1 to 3 and Comparative Examples 1 and 2 was performed on 50 healthy pet dogs at an age of 2 to 14. 100 g of the ramen for a companion animal of Examples and 100 g of the ramen for a companion animal of Comparative Examples were simultaneously supplied to each pet dog. Palatability of a corresponding snack was investigated on a 10-point scale, and an owner of a corresponding pet dog directly observed the pet dog to then evaluate the palatability evaluation. Results thereof are shown in Table 1 below. In this case, a palatability evaluation value is obtained by dividing the sum of points given by guardians of the pet dogs by the number of the guardians and then rounding up the resultant value to two decimal places and means that, as the value is increased, palatability is high. Results thereof are shown in Table 1.

TABLE 1

| | | | Exam- | Comparative | Comparative |
|---|---|---|---|---|---|
| | Example 1 | Example 2 | ple 3 | Example 1 | Example 2 |
| Palatability | 9.1 | 9.0 | 9.2 | 6.4 | 7.9 |

As shown in Table 1, it can be seen that the palatability of the ramen for a companion animal according to the present disclosure is excellent as compared with Comparative Examples 1 and 2.

### [Experimental Example 2] Sensory Evaluation 2

Sensory evaluation was performed on Examples 1 to 3 and Comparative Examples 1 and 2.

Since the ramen for a companion animal according to the embodiment of the present disclosure can be ingested by humans, humans participated in an experiment for more accurate sensory evaluation.

Among trained professional sensory test personnel (50 personnel [25 men and 25 women] with more than 2 years of sensory test experience), 30 personnel with a relatively excellent taste were selected and tasted a manufactured noodle snack, and then, a quantitative descriptive analysis (QDA) was performed on a flavor, noodle roughness, a taste, a texture, and palatability. A sensory test was performed using a 5-point measurement method (1: very bad, 2: bad, 3: average, 4: good, and 5: very good). Results of the sensory test are shown in Table 2. After one was ingested to perform evaluation, a mouth was surely rinsed with water, and then, another one was ingested to perform evaluation.

TABLE 2

| | | Noodle | | | |
|---|---|---|---|---|---|
| | Flavor | roughness | Taste | Texture | Palatability |
| Example 1 | 4.3 | 4.2 | 4.2 | 4.3 | 4.5 |
| Example 2 | 4.4 | 4.3 | 4.3 | 4.2 | 4.5 |
| Example 3 | 4.5 | 4.2 | 4.4 | 4.3 | 4.6 |
| Comparative | 2.8 | 4.2 | 3.2 | 4.2 | 2.8 |
| Example 1 | | | | | |
| Comparative | 4.2 | 4.1 | 4.2 | 2.8 | 3.0 |
| Example 2 | | | | | |

As can be seen from Table 2, it can be seen that Examples 1 to 3 are excellent in all items.

More specifically, when Example 1 is compared with Examples 2 and 3, although each of a nutrient extract and a functional pulverized raw material is added to Example 1, similar results can be confirmed.

Accordingly, even though a nutrient extract or a functional pulverized raw material is added to the ramen for a companion animal of the present disclosure, palatability may be maintained, and various nutrients may be additionally supplied, thereby providing nutritionally excellent ramen for a companion animal.

In addition, when Example 1 is compared with Comparative Examples 1 and 2, it can be seen that the palatability of Comparative Examples 1 and 2 is lower than that of Example 1.

More specifically, in the case of Comparative Example 1, it can be seen that, as parts by weight of a hwangtae are increased, a flavor and taste are lowered, and in the case of Comparative Example 2, it can be confirmed that, a size of a pulverized raw material is increased, a texture is lowered.

As described above, ramen for a companion animal according to embodiments of the present disclosure has excellent palatability, includes various nutrients, and is formed in the form of noodles, thereby enabling a companion animal to ingest high quality noodle snacks.

Although the embodiments of the present disclosure have been described in detail, it will be understood that the scope of the present disclosure is not limited to the above described embodiments, and any variations and modifications by a person having ordinary skill in the art using the basic concept and spirit defined in the following claims are within the scope of the present disclosure.

1. Ramen for a companion animal, comprising:
noodles including a grain raw material and an additive raw material; and
soup powder including a powder raw material, a pulverized raw material, and an additional raw material.

2. The ramen of claim 1, wherein the grain raw material includes at least one selected from whole wheat, wheat flour, waxy barley, rice starch, and corn starch.

3. The ramen of claim 2, wherein the grain raw material includes the whole wheat in an amount of 25 to 35 parts by weight, the wheat flour in an amount of 5 to 35 parts by weight, the waxy barley in an amount of 15 to 25 parts by weight, the rice starch in an amount of 10 to 15 parts by weight, and the corn starch in an amount of 2 to 6 parts by weight.

4. The ramen of claim 1, wherein the additive raw material includes at least one selected from among egg yolk powder, vitamin B2, an acidity regulator, and an oligo green tea flavor liquid.

5. The ramen of claim 1, wherein the noodles further include a nutrient extract including at least one selected from among fennel, radish, myrrh, and radish seed.

6. The ramen of claim 1, wherein the soup powder includes the powder raw material in an amount of 65 to 75 parts by weight, the pulverized raw material in an amount of 25 to 35 parts by weight, and the additional raw material in an amount of 0.1 to 0.5 parts by weight.

7. The ramen of claim 1, wherein the powder raw material includes at least one selected from dried pollack, chicken, egg yolk, sweet pumpkin, banana, spinach, and broccoli in a form of dried powder.

8. The ramen of claim 7, wherein the powder raw material includes the dried pollack in an amount of 25 to 35 parts by weight, the chicken in an amount of 8 to 12 parts by weight, the egg yolk in an amount of 15 to 25 parts by weight, the sweet pumpkin in an amount of 2 to 8 parts by weight, the banana in an amount of 2 to 6 parts by weight, the spinach in an amount of 0.3 to 0.7 parts by weight, and the broccoli in an amount of 0.3 to 0.7 parts by weight.

9. The ramen of claim 1, wherein the pulverized raw material includes at least one selected from among of apple, carrot, and cabbage, which is cut into a size of 0.3 cm to 0.7 cm and dried.

10. The ramen of claim 9, wherein the pulverized raw material further includes a functional pulverized raw material, and
the functional pulverized raw material includes at least one selected from among of chicon, parsnip, wax gourd, and ice plant.

11. The ramen of claim 1, wherein the additional raw material includes at least one selected from among a bonito fragrance, coconut oil, and a lactic acid bacterium.

12. A method of manufacturing ramen for a companion animal, the method comprising:
kneading a mixture including a grain raw material and an additive raw material to prepare mixture dough;
extruding the mixture dough to prepare noodles;
steaming the noodles using steam and then molding the steamed noodles;
finishing manufacturing of the noodles by frying and then cooling the molded noodles; and
mixing a powder raw material, a pulverized raw material, and an additional raw material to prepare soup powder.
